(19) United States
(12) Patent Application Publication
(10) Pub. No.: US 2007/0061063 A1
(43) Pub. Date: Mar. 15, 2007

(54) Method for regulating deceleration of a motor vehicle

(75) Inventors: Erwin Bauer, Lappersdorf (DE); Dietmar Ellmer, Regensburg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/519,525

(22) Filed: Sep. 12, 2006

(30) Foreign Application Priority Data
Sep. 12, 2005 (DE) 10 2005 043 370.7

(51) Int. Cl. B60K 6/00; G06F 19/00; F01L 13/06

(52) U.S. Cl. 701/110; 123/320; 180/65.2

(57) ABSTRACT

The present invention relates to a method for regulating deceleration of a motor vehicle. In the context of this method, braking torques generated by charging processes in the motor vehicle are compensated for by targeted actuation of gas exchange elements. By setting the deceleration of the vehicle achieved by charging processes at a certain desired value, a comfortable operation of the motor vehicle is achieved.

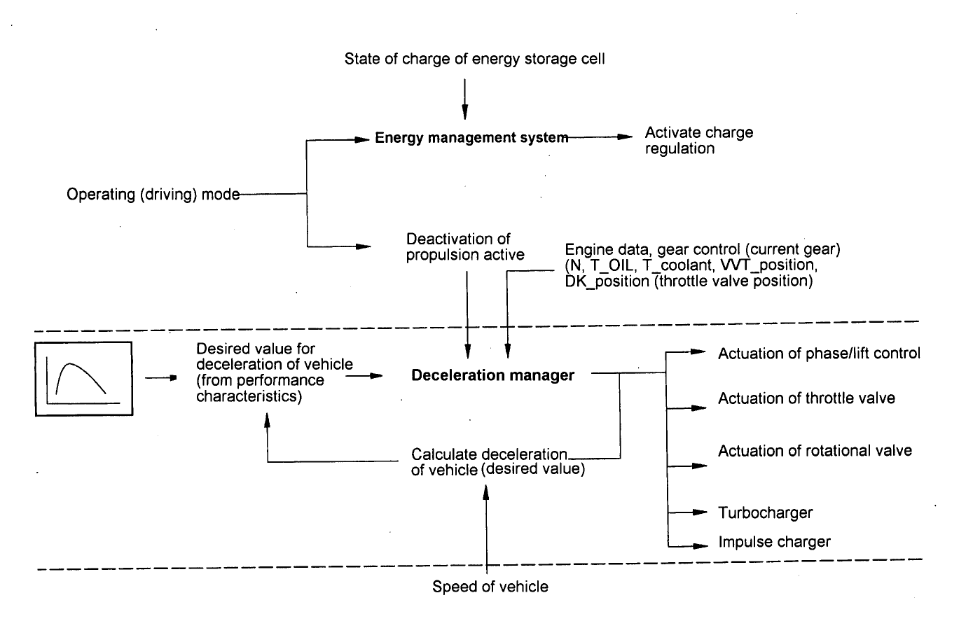

### CROSS REFERENCE TO RELATED APPLICATIONS

This application claims the benefits of German Patent application No. 10 2005 043 370.7 filed Sep. 12, 2005 and is incorporated by reference herein in its entirety.

### FIELD OF THE INVENTION

The present invention relates to a method for regulating deceleration of a motor vehicle in order to be able to make optimum use of the energy that has been converted and in some cases stored in the motor vehicle.

### BACKGROUND OF THE INVENTION

Modem motor vehicles are equipped with a plurality of electric consumers. These include, for example, heated rear windows and windscreens, electric window motors, additional heating, seat- and steering wheel adjusters and also various lights. All these consumer loads have in common the fact that they are a drain on the motor vehicle's electrical system. The desired electrical output ultimately has to be provided by the internal combustion engine itself by, for example, the alternator demanding a certain torque when power is required by an electric consumer in the internal combustion engine.

Various strategies for energy management within the motor vehicle are part of the prior art. The basis of these strategies lies in utilizing those operating phases of the internal combustion engine that are particularly efficient at providing energy, that is, for charging energy storage cells. These efficient operating phases of the internal combustion engine are the propulsion phases. During these propulsion phases, electrical energy storage cells, such as, for example, accumulators or so-called Supercaps, are charged with the aid of the alternator. In principle, it is likewise conceivable for energy storage cells of any kind at all, such as mechanical springs even, to be charged during the propulsion phase. It is a disadvantage, however, that by charging the energy storage cells during the propulsion phase, the internal combustion engine is encumbered by a braking torque, whilst an additional braking torque could contribute to energy-saving, when the motor vehicle slows down, for example.

### SUMMARY OF THE INVENTION

Energy management to control the above charging phase allows a defmed braking torque to be applied to the internal combustion engine. The gas exchange loop in a spark-ignition engine can likewise be interpreted as braking torque in such cases. By regulating the gas exchange elements, such as the throttle valve, the rotational valve or the phase and lift controls, a varying degree of throttling or dethrottling of the internal combustion engine can be achieved, in order to overcome the aforementioned braking torque.

The present invention addresses the problem of providing a method for regulating the deceleration of a motor vehicle, with which both greater comfort in the motor vehicle can be achieved for the driver and improved utilization of the energy converted in the motor vehicle is possible.

The above object is achieved by a method for regulating the deceleration of a motor vehicle according to the claims. This method serves the purpose of achieving a constant deceleration of the motor vehicle by means of a skilful combined action of dethrottling measures of the internal combustion engine and energy management in all operating phases of the internal combustion engine irrespective of the road contours. The constant deceleration of the motor vehicle results in greater convenience for the driver compared with known motor vehicles. In addition, irreversible energy-conversion processes, such as braking by the driver, for example, can be replaced in a targeted manner with reversible energy-conversion processes, such as charging and discharging a battery, for example, the braking torque of charging processes being used in a targeted manner in deceleration phases of the motor vehicle.

The method according to the invention for regulating the deceleration of a motor vehicle encompasses the following steps: acquiring the operating data for the motor vehicle in order to determine the operational state thereof, defining a desired value for a vehicle's deceleration on the basis of at least one charging process of an energy storage cell in the motor vehicle and determining the vehicle's deceleration on the basis of the charging process of the at least one energy storage cell and activating a gas exchange element in the motor vehicle in such a way that the vehicle's deceleration concurs with the desired value in order to achieve comfortable operation of the motor vehicle.

As a result of the aforementioned regulation of deceleration in the motor vehicle, it is guaranteed that the motor vehicle in its various operational states is always encumbered only by a maximum deceleration of the vehicle that has been set at a desired value on the basis of charging processes of energy storage cells in the motor vehicle. This allows a uniform operation of the motor vehicle in both acceleration and deceleration phases. Even when charging processes of energy storage cells that would produce a deceleration of the vehicle greater than the desired value that has been set are required in the motor vehicle, the aforementioned deceleration of the vehicle is compensated for by a targeted dethrottling of the internal combustion engine. In the same way compensation is achieved by the gas exchange elements of the motor vehicle, if charging processes of the energy storage cells are intended to deliver a deceleration of the vehicle lower than the set desired value.

According to one embodiment of the method for regulating deceleration, the deceleration of the vehicle is kept at a constant level during a propulsion phase of the motor vehicle.

According to a further embodiment of the method for regulating deceleration, the creation of a maximum charging process is achieved during the propulsion phase of the internal combustion engine and compensation of deceleration of the vehicle in excess of the desired value is achieved by dethrottling the motor vehicle's internal combustion engine.

According to a-further embodiment of the present method, for regulating deceleration, adjustment of the vehicle's deceleration is achieved by charging processes that are dependent on the operational state of the motor vehicle, in particular when the vehicle is traveling downhill and uphill, in order to achieve additional braking of the motor vehicle by reinforcing the charging processes in the motor vehicle whilst at the same time generating energy or in order to achieve less braking by reducing the charging processes. It is likewise conceivable in the above method for the desired value for the vehicle's deceleration to be defined as a function of the operational state of the motor vehicle.

### BRIEF DESCRIPTION OF THE DRAWINGS

The present invention and the preferred embodiments thereof are explained in more detail with the aid of the accompanying drawing. Different embodiments and variants of the present invention can be inferred from the description and also from the dependent claims. The accompanying FIGURE shows a block diagram to explain the functioning of the method for the.regulation of the deceleration of the motor vehicle.

### DETAILED DESCRIPTION OF THE INVENTION

The various energy storage cells in a motor vehicle can be charged in a targeted manner with the aid of an energy management system, e.g. of a charging current regulator. These charging processes result in a defined braking torque, which is applied to the motor vehicle's internal combustion engine. The greater the required charge output for the charging process, for example the greater the charging current, the greater is the braking torque and hence the effective deceleration of the vehicle that is produced by the charging process. If the intensity of the charging processes and consequently the deceleration of the vehicle varies, for example in the propulsion phase of the internal combustion engine, this leads firstly to an uncomfortable and undesirable “juddering” during the operation of the motor vehicle. Secondly, in order to save fuel, it would be desirable to use the propulsion phases of the internal combustion engine as efficiently as possible for charging the energy storage cells in the motor vehicle. The result thereof is that, depending on the state of charge of the energy storage cells of the motor vehicle, charging occurs at different and sometimes excessively high levels during the propulsion phase, as a result whereof braking effects of varying intensity are created.

These braking torques, which lead to an uncomfortable operation of the motor vehicle, are eliminated by the present method for regulating the deceleration of the motor vehicle. For this purpose, the operating data of the motor vehicle is first determined in order to ascertain the motor vehicle's operational state. This operating data includes information about the state of the internal combustion engine, the gear control, and other systems connected to the internal combustion engine which determine the operation of the motor vehicle. This operating data is, for example, the rpm N, the oil temperature of the internal combustion engine T_OIL, the temperature of the coolant of the internal combustion engine T_coolant, the position of the variable valve timing VVT_Position and the position of the throttle valve DK_Position (see FIGURE). Once acquired, this operating data is transmitted for instance to the engine management system where it is evaluated. The evaluation supplies the operational state and/or a driving or operational mode of the motor vehicle.

The various energy storage cells in the motor vehicle, such as, for example, the battery, Supercaps, mechanical storage units or hydraulic storage elements, are monitored with the aid of an energy management system, charged and discharged again in a targeted manner in order to supply with energy consumer loads connected thereto. For this purpose, suitable sensors, for example, transmit the state of charge of the energy storage cells to the energy management system, in order to be able to regulate accordingly the intensity of charging processes in the energy storage cells. The energy management system thus manages the information, as to the intensity required for charging processes in certain energy storage cells and the braking torque applied to the motor vehicle's internal combustion engine in these charging processes. As shown in the FIGURE, charge regulation of the respective energy storage cells is activated by the energy management system where a charging process is necessary.

So that the braking torques generated by the different charging processes generate a regulated deceleration of the motor vehicle, the energy management system is operated in collaboration with a deceleration manager. The accompanying FIGURE shows by way of example the collaboration of the energy management system and the deceleration manager in the operational phase of deactivation of propulsion of the internal combustion engine. Such a deactivation of propulsion ensues when the motor vehicle is on a downhill run, in which the downhill motive force ensures sufficient propulsion as a result of the vehicle's own weight. During this downhill run of the motor vehicle, a desired value for deceleration of the vehicle is first defined on the basis of at least one charging process of an energy storage cell in the motor vehicle, in order to avoid an uncomfortable driving experience for the driver as the result of the activation and deactivation of charging processes and the braking torques associated therewith. This desired value establishes that the braking effect generated by charging processes shall assume an approximately constant value so that the charging processes of the energy storage cells that take place in the motor vehicle are no longer perceptible to the driver.

Compared to this desired value, the braking torques and consequently the deceleration of the vehicle that are generated by the charging processes initiated by the energy management system of the energy storage cells that are intended to be charged up are determined. In order to simplify the determination of the deceleration of the vehicle on the basis of one or a plurality of charging processes, corresponding performance characteristics in the motor vehicle, in the engine management system, for example, are stored.

In the deceleration manager, the deceleration of the vehicle that is actually achieved by the charging processes is compared with the desired value that has been set for the deceleration of the vehicle. Depending on the result of the comparison, actuation of at least one gas exchange element of the motor vehicle ensues in such a way that the deceleration of the vehicle that is actually generated concurs with the desired value in order to guarantee a comfortable operation of the motor vehicle. Gas exchange elements actuated by the deceleration manager are, for example, phase and lift controls, a throttle valve, a rotational valve, a turbocharger and/or an impulse charger. If, for example, the actual deceleration of the vehicle is, as a result of charging processes, greater than the desired value that has been set, the deceleration manager actuates an additional propulsion of the internal combustion engine via one or a plurality of gas exchange elements such that the deceleration of the vehicle that is in excess of the desired value is compensated for by charging processes by means of the aforementioned propulsion. The aforementioned regulation on the part of the deceleration manager is monitored, the actual value for the deceleration of the vehicle being calculated and compared with the desired value. In this regulating circuit the speed of the motor vehicle is likewise entered.

Consequently, the interaction with the gas exchange elements allows in the main for compensation of the differences in the braking torques generated by the charging processes. High braking torques are neutralized by charging processes, the gas exchange being inhibited as a function of the road contour and according to the generator's braking torque, that is, closure of the throttle valve/rotational valve, or activated, that is, opening of the throttle valve/rotational valve. Particularly advantageous here is the use of components that are easy to adjust, such as, for example, an impulse charger or an electric variable valve timer, which regulate the phase and/or also the valve lift. In this way, the gas exchange braking torque can be influenced quickly and sensitively by targeted intervention with the valve timing, that is, using the strategy “late intake closing—early discharge opening” and or by targeted intervention with valve lift.

It is therefore preferable to maintain the deceleration of the vehicle at a constant level during a propulsion phase of the motor vehicle's internal combustion engine, in order to produce a comfortable driving experience in this way. According to a further embodiment of the present method, the deceleration of the vehicle that can be generated by charging processes is adjusted to the operational state of the motor vehicle. This means that, as a function of a propulsion phase of the motor vehicle, for example driving uphill, or of a phase when propulsion is deactivated, for example, driving downhill, a varying intensity of charging processes or a varying deceleration of the vehicle is initiated, in order to use the braking torques of the charging processes in a targeted manner in operational conditions where a braking effect of the motor vehicle is required. In this way, the charging processes assist with the deceleration of the motor vehicle, whilst at the same time the braking processes are used for energy storage. “Energy destruction” through the activation of the motor vehicle's brakes, whereby kinetic energy is converted into heat that is no longer usable for the motor vehicle, is thus avoided. Thus irreversible energy conversion processes are replaced by reversible energy conversion und energy storage processes. Whilst the increased activation of charging processes leads to a supportive and energy-friendly deceleration of the motor vehicle, a reduced intensity of charging processes during a propulsion phase of the internal combustion engine can also lead to energy-saving.

The aforementioned adjustment of the deceleration of the vehicle to the operational state of the motor vehicle by means of charging processes can likewise be achieved by the desired value for the deceleration of the vehicle being varied or defined as a function of the operational state of the motor vehicle. In this way, the size of the desired value, which is constantly adjusted to the operational state of the internal combustion engine as a function of selectable operational values of the internal combustion engine, a more comfortable operation of the motor vehicle and an environmentally aware use of energy is provided and implemented in collaboration with the energy management system and the deceleration manager.

By means of the aforementioned method for regulating deceleration of the motor vehicle, the motor vehicle is thus always constantly decelerated in the propulsion phase, irrespective of the road contour, that is of the section of road that the vehicle has traveled along with its upward and downward inclines, which makes driving more comfortable. The aforementioned deceleration is not sufficient to keep the motor vehicle at a constant speed in the case of a steep downward incline. However, the option of phase adjustment in the case of early opening of the discharge valves allows a considerable additional braking torque to be built up, that is, by reduced expansion work being put in to accelerate the pistons. As a result thereof, the brakes of the motor vehicle are likewise used sparingly.

A further gain in comfort is achieved by the fact that the motor vehicle is decelerated to the same degree when the internal combustion engine is running cold and when it is running hot in spite of the different frictional ratios, that is, the differences in viscosity between hot and cold motor oil. Furthermore, a constantly high to maximum charging current can be driven in the propulsion phases of the internal combustion engine, without the motor vehicle being slowed down to an excessive extent since the braking torque can be compensated for by dethrottling. This ultimately improves fuel consumption. Furthermore, rapid changes in the torque in the internal combustion engine can be compensated for by fast gas exchange elements (see above). Irreversible processes such as, for example, the aforementioned braking, are replaced by reversible processes, such as, for example, charging of energy storage cells, as a result of which wear and tear are reduced and energy is saved. There is a particular advantage in motor vehicles that have automatic gears. When traveling downhill, conventional gearboxes constantly move into higher and higher gears and in the process become faster and faster, which generally involves an uncomfortable and unpleasant juddering. Concomitant with gear regulation, firstly the acceleration of the motor vehicle can be controlled when traveling downhill and secondly, the juddering is reduced by targeted use of the throttling elements and thus a clear gain in convenience can be achieved.

1-5. (canceled)

6. A method for regulating deceleration of a motor vehicle having an internal combustion engine, comprising:
acquiring operational data of the vehicle;
determining an operating state of the vehicle based on the acquired operational data;
defining a desired value for a deceleration of the vehicle based on a charging process of an energy storage cell in the motor vehicle;
determining an actual deceleration of the vehicle on the basis of the charging process of the energy storage cell; and
actuating a gas exchange element of the motor vehicle such that the deceleration of the vehicle agrees with the desired value to achieve a comfortable operation of the motor vehicle.

7. The method according to claim 6, wherein the deceleration of the vehicle is constant during a propulsion phase of the motor vehicle.

8. The method according to claim 7, further comprising,
generating a maximum charging process during the propulsion phase, and
de-throttling the engine of the vehicle if the deceleration of the vehicle exceeds the desired value.

9. The method according to claim 6, further comprising,
adjusting the deceleration of the vehicle by regulating a charging processes as a function of the operational state of the motor vehicle to achieve an additional deceleration of the motor vehicle by increasing the charging processes in the motor vehicle.

10. The method according to claim 9, wherein the desired value for the deceleration of the vehicle is a function of the operational state of the motor vehicle.

11. The method as claimed in claim 6, wherein the vehicle includes a plurality of energy storage cells.

12. The method as claimed in claim 11, wherein the vehicle deceleration rate is adjusted by regulation of the plurality of energy storage cells.

13. The method as claimed in claim 6, wherein the vehicle includes a plurality of gas exchange elements.

14. The method as claimed in claim 13, wherein the vehicle deceleration rate is adjusted by regulation of the plurality of gas exchange elements.

15. A method of regulating a motor vehicle, comprising:
determining an operational state of the motor vehicle;
determining a desired vehicle deceleration rate based on a charging process of an energy storage cell of the motor vehicle and the operational state of the motor vehicle;
determining the actual deceleration of the vehicle on the basis of the charging process of the energy storage cell;
comparing the actual deceleration rate of the vehicle to the desired deceleration rate of the vehicle; and
regulating the actual deceleration rate of the vehicle based on the comparison by actuating a plurality of gas exchange elements of the vehicle.

16. The method as claimed in claim 15, wherein the deceleration of the vehicle is constant during a propulsion phase of the motor vehicle.

17. The method as claimed in claim 15, wherein the deceleration of the vehicle is regulated by a deceleration manager.
